(19) United States
(12) Patent Application Publication
(10) Pub. No.: US 2014/0067915 A1
(43) Pub. Date: Mar. 6, 2014

(54) TERMINAL DEVICE AND DATA COMMUNICATION METHOD THEREOF

(71) Applicant: SAMSUNG ELECTRONICS CO., LTD., Suwon-si (KR)

(72) Inventor: Jin-wook CHOI, Suwon-si (KR)

(73) Assignee: Samsung Electronics Co., Ltd., Suwon-si (KR)

(21) Appl. No.: 13/847,139

(22) Filed: Mar. 19, 2013

(30) Foreign Application Priority Data
Sep. 3, 2012 (KR) 10-2012-0097260

(51) Int. Cl. H04L 29/06

(52) U.S. Cl. CPC H04L 67/42
USPC 709/203

(57) ABSTRACT

A terminal device and a data communication method of the terminal device in which a virtual environment is constructed includes receiving a processing command for data searched for according to a data search command, storing first path information on a position of the searched data and transmitting first event information related to the processing command to a management server, receiving a communication performance command including identification information of the other terminal device from the management server, and transmitting the data to the other terminal based on the identification information and the first path information, wherein the communication performance command is generated based on second event information related to an execution command for the data in the other terminal device and the first event information. Data transmission/reception between the virtual terminal devices or between the virtual terminal device and an actual terminal device can be performed smoothly.

### CROSS-REFERENCE TO RELATED APPLICATIONS

This application claims the priority benefit under 35 U.S.C. §119(a) of Korean Patent Application No. 10-2012-0097260 filed on Sep. 3, 2012, in the Korean Intellectual Property Office, the disclosure of which is incorporated herein by reference.

### BACKGROUND

1. Field

The following description relates to a terminal device and a data communication method thereof, and more particularly to a terminal device in which a virtual environment is constructed and a data communication method for performing data communication between virtual or actual terminal devices.

2. Description of the Related Art

In general, a terminal device in which a virtual Windows environment or a virtual Linux environment is constructed (hereinafter referred to as a virtual terminal device) uses data copy, cut, paste, and drag and drop in order to transmit data stored in a specific position to another virtual terminal device or a terminal device under an actual Windows environment or an actual Linux environment (hereinafter referred to as an actual terminal device).

For example, a virtual terminal device that transmits data may be a source terminal device, and an actual terminal device that receives the corresponding data may be a target terminal device. In order to transmit/receive data between a source terminal device and a target terminal device, it is necessary for any one of the source terminal device and the target terminal device to manually open directories of the source terminal device and the target terminal device (information on a path where data to be transmitted is located and a path where the corresponding data is stored), which is an inconvenience.

In addition, in order to transmit/receive data between virtual terminal devices, it is necessary for two virtual terminal devices to use the same communication protocol for data transmission/reception between the two virtual terminal devices. That is, if the two virtual terminal devices use different communication protocols, the data transmission/reception between the virtual terminal devices may not be performed smoothly.

### SUMMARY

The present disclosure has been made to address at least the above problems and/or disadvantages and to provide at least the advantages described below. Accordingly, an aspect of the present disclosure is to achieve smooth data transmission/reception between a virtual terminal device and a virtual or actual terminal device.

According to an aspect of the present disclosure, a data communication method of a first terminal device in which a virtual environment is constructed includes receiving, by the first terminal device, a processing command for data searched for according to a data search command; storing, by the first terminal device, first path information on a position of the searched data and transmitting first event information related to the processing command to a management server; receiving, by the first terminal device, a communication performance command including identification information of the second terminal device from the management server; and transmitting the data to the second terminal based on the identification information and the first path information, wherein the communication performance command is generated based on second event information related to an execution command for the data in the second terminal device and the first event information.

The first event information may be one of data cut, copy, and drag, and the second event information may be one of data paste and drop.

The first terminal device may be a source terminal device that provides the data, and the second terminal device may be a target terminal device that receives the data from the source terminal device.

The virtual environment may be an execution environment that is generated based on resources stored in an external server.

The first terminal device may perform communication with the second terminal device using a Peer to Peer (P2P) method.

According to an aspect of the present disclosure, a data communication method of a second terminal device in which a virtual environment is constructed includes receiving, by the second terminal device, first event information related to a data processing command of a first terminal device from a management server if a data search command is received; providing a user interface (UI) for executing data stored in the other terminal device based on the received first event information; if an execution command is received through the UI, transmitting second event information related to the received execution command to the management server; and receiving the data by performing communication with the first terminal device according to a communication performance command received from the management server, wherein the communication performance command is generated based on the first event information and the second event information.

The data communication method according to the aspect of the present disclosure may further include storing second path information to execute the data if the execution command is input; and storing the received data in a position that corresponds to the second path information.

The first event information may be one of data cut, copy, and drag, and the second event information may be one of data paste and drop.

The second terminal device may be a target terminal device that receives the data, and the first terminal device may be a source terminal device that provides the data, and the virtual environment may be an execution environment that is generated based on resources stored in an external server.

The second terminal device may perform communication with the first terminal device using a Peer to Peer (P2P) method.

According to an aspect of the present disclosure, a first terminal device in which a virtual environment is constructed includes a communicator performing communication with a management server and a second terminal device; a user interface receiving and using a processing command for data searched for according to a data search command; a storage unit storing first path information on a position of the searched data; and a controller transmitting first event information related to the processing command to the management server, and if a communication performance command including identification information of the second terminal device is received from the management server, transmitting the data to the second terminal based on the identification information and the first path information, wherein the communication performance command is generated based on second event information related to an execution command for the data in the second terminal device and the first event information.

The first event information may be one of data cut, copy, and drag, and the second event information may be one of data paste and drop.

The first terminal device may be a source terminal device that provides the data, and the second terminal device may be a target terminal device that receives the data from the source terminal device.

The virtual environment may be an execution environment that is generated based on resources stored in an external server.

The communicator may perform communication with the second terminal device using a Peer to Peer (P2P) method.

According to an aspect of the present disclosure, a second terminal device in which a virtual environment is constructed includes a communicator performing communication with a management server and a first terminal device; a user interface receiving a data search command; a UI provider receiving first event information from the management server if the data search command is received, and providing a UI for executing data stored in the first terminal device based on the received first event information; and a controller transmitting second event information related to an execution command to the management server if the execution command is received through the UI, and performing communication with the first terminal device according to a communication performance command received from the management server to receive the data, wherein the communication performance command is generated based on the first event information and the second event information.

The second terminal device according to the aspect of the present disclosure may further include a storage unit storing second path information to execute the data, wherein the controller executes the received data in a specific position that corresponds to the second path information if the data is received.

The first event information may be one of data cut, copy, and drag, and the second event information may be one of data paste and drop.

The second terminal device may be a target terminal device that receives the data, and the first terminal device may be a source terminal device that provides the data, and the virtual environment may be an execution environment that is generated based on resources stored in an external server.

The second terminal device may perform communication with the first terminal device using a Peer to Peer (P2P) method.

A system for performing data communication between a first terminal device and a second terminal device, the system including: receiving, by the first terminal device, a first data processing command; storing, by the first terminal device, information related to the received command; transmitting, by the first terminal device, the stored information to a management server; receiving, by the second terminal device, a second data processing command related to the first data processing command; and receiving, by the second terminal device, the transmitted stored information from the management server.

According to various aspects of the present disclosure as described above, the data transmission/reception between the virtual terminal devices or between the virtual terminal device and the actual terminal device can be performed smoothly.

### BRIEF DESCRIPTION OF THE DRAWINGS

The above and other aspects, features and advantages of the present disclosure will be more apparent from the following detailed description when taken in conjunction with the accompanying drawings, in which:

FIG. 1 is a procedure diagram of a method for performing communication between virtual or actual terminal devices in a communication system according to an embodiment of the present disclosure;

FIG. 2 is a block diagram of a terminal device, in which a virtual environment is constructed, providing data to the other terminal device according to an embodiment of the present disclosure;

FIG. 3 is a block diagram of a terminal device, in which a virtual environment is constructed, receiving data of the other terminal device according to an embodiment of the present disclosure;

FIG. 4 is a flowchart of a method for providing data from a terminal device, in which a virtual environment is constructed, to a virtual or actual terminal device according to an embodiment of the present disclosure; and

FIG. 5 is a flowchart of a method for receiving data of a virtual or actual terminal device through a terminal device in which a virtual environment is constructed according to an embodiment of the present disclosure.

### DETAILED DESCRIPTION

Hereinafter, embodiments of the present disclosure are described in detail with reference to the accompanying drawings.

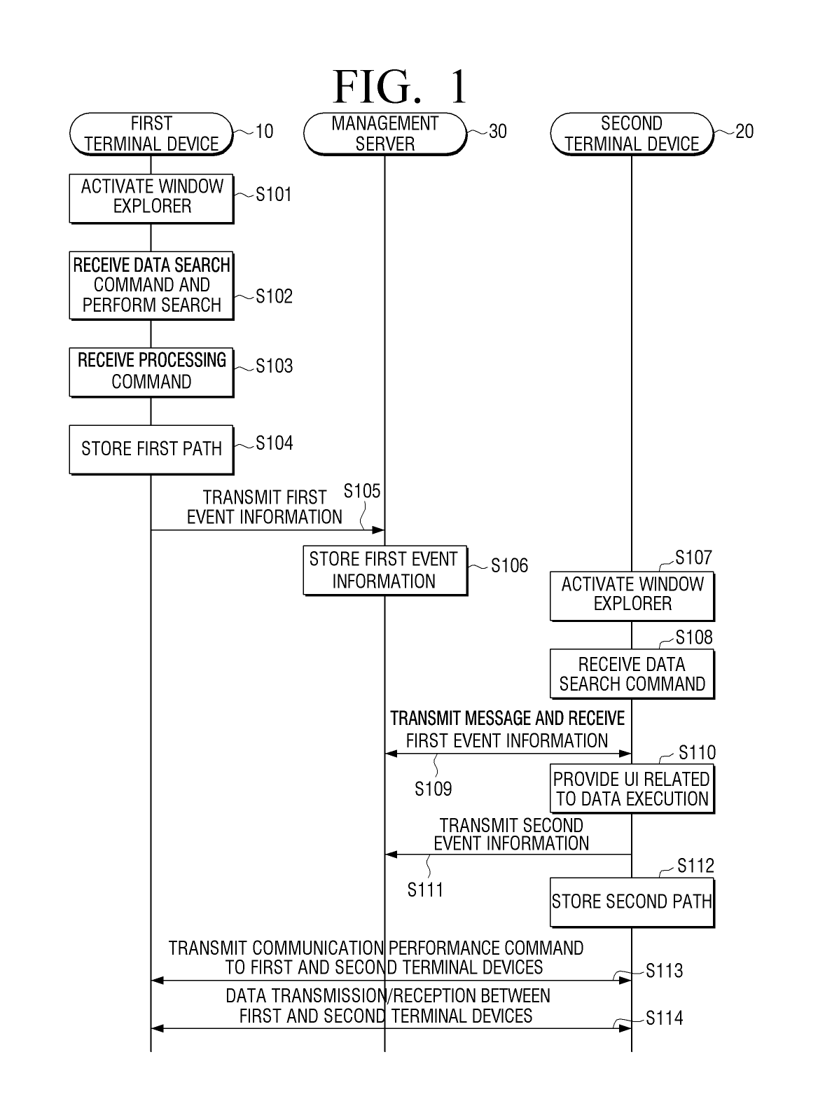

As illustrated in FIG. 1, a communication system includes a first terminal device 10 in which a virtual environment is constructed, a second terminal device 20, and a management server 30 managing event information of the first terminal device 10 and the second terminal device 20. Here, the term “virtual environment” may be an execution environment generated based on resources stored in an external server. Accordingly, different virtual Windows environments may be constructed in the first terminal device 10 and the second terminal device 20 based on the resources stored in the external server. However, the present disclosure is not limited thereto. The first terminal device 10 or the second terminal device 20 may be a terminal device in which a virtual environment is constructed, and the remaining terminal device may be a terminal device in which an actual Windows environment is constructed. In the present disclosure, explanation will be made only with respect to a case where different virtual environments are constructed in the first terminal device 10 and the second terminal device 20.

According to an embodiment of the present disclosure, the first terminal device 10 may be a source terminal device that provides data, and the second terminal device 20 may be a target terminal device that receives the data. However, the present disclosure is not limited thereto. The first terminal device 10 may be the target terminal device that receives the data, and the second terminal device 20 may be the source terminal device that provides the data to the first terminal device 10. According to the present disclosure, it is assumed that the first terminal device 10 is the source terminal device that provides the data to the second terminal device 20, and the second terminal device 20 is the target terminal device that receives the data provided from the first terminal device 10.

Of the first terminal device 10 and the second terminal device 20 in which different virtual environments are constructed, the first terminal device 10 activates the Windows explorer according to a user request (operation S101). If a data search command for at least one piece of data among a plurality of pieces of pre-stored data is received from a user when the Windows explorer is activated, the first terminal device 10 searches for the data that corresponds to the received data search command (operation S102). Thereafter, if a processing command for the searched data is received from the user, the first terminal device 10 stores first path information on the position where the searched data is stored (operation S103 and operation S104). Here, the processing command for the searched data may be one of cut, copy, and drag for the corresponding data. The first path information includes a local directory where the searched data is stored and data position information.

Accordingly, if one processing command among the cut, copy, and drag for the searched data is received, the first terminal device 10 may store the first path information that includes the local directory and the data position information for the position where the corresponding data is stored. If the processing command for copy is received, the first terminal device 10 may store the first path information that includes the local directory and data position information to perform copy of the data stored in the first terminal device 10 based on the received processing command.

In addition, if the processing command for the searched data is received, the first terminal device 10 transmits first event information related to the processing command to the management server 30 (operation S105). Here, the first event information includes information on one processing command for cut, copy, and drag of the searched data and identification information of the first terminal device 10, that is, address information. The management server 30 which has received the first event information stores the received first event information (operation S106).

As described above, when the first event information of the first terminal device 10 is stored in the management server 30, the second terminal device 20 activates the Windows explorer according to a user request (operation S107). When the Windows explorer is activated as described above, the second terminal device 20 receives a data search command for at least one piece of data among the pre-stored plurality of pieces of data from the user (operation S108). If the data search command is received, the second terminal device 20 transmits an event occurrence message that notifies of the reception of the data search command to the management server 30. If this data is received, the management server 30 transmits the first event information that is stored related to the processing command for the data searched in the first terminal device 10 to the second terminal device 20 (operation S109). However, the present disclosure is not limited thereto. If the Windows explorer is activated, the second terminal device may transmit the event occurrence message that notifies of the activation of the Windows explorer to the management server 30, and thus the management server 30 may transmit the first event information that is stored related to the data processing command of the first terminal device 10 to the second terminal device 20.

If the first event signal is received, the second terminal device 20 provides a UI for executing the data stored in the first terminal device 10 based on the first event information (operation S110). If the execution command is received from the user through the corresponding UI in the state where the UI has been provided, the second terminal device 20 transmits second event information related to the received execution command to the management server 30 (operation S111). In addition, the second terminal device 20 stores second path information for executing the data stored in the first terminal device based on the received execution command (operation S112). Here, the execution command may be one of paste and drop for storing the data stored in the first terminal device 10 in a specific position. The second event information includes one execution information of paste and drop for the corresponding data and identification information of the second terminal device 20, that is, address information. Further, second path information includes local directory information for storing the data stored in the first terminal device 10 in a specific position.

If the execution command for paste is received, the second terminal 20 generates and stores the second path information that includes the local directory information related to the specific position to perform paste for the data stored in the first terminal device 10 based on the received execution command. In addition, the second terminal device 20 generates the second event information that includes the execution information related to paste and the address information of the second terminal device 20, and transmits the second event information to the management server 30.

On the other hand, if the second event information is received from the second terminal 20, the management server 30 determines the first terminal device 10 that is the source terminal device and the second terminal device 20 that is the target terminal device based on the pre-stored first event information and the second event information received from the second terminal device 20. That is, the management server 30 generates a communication performance command for performing communication between the first terminal device 10 and the second terminal device 20 based on the first event information and the second event information and transmits the generated communication performance command to the first terminal device 10 and the second terminal device 20 (operation S113). Here, the communication performance command that is transmitted to the first terminal device 10 is a performance command for performing data transmission to the second terminal device 20, and includes the second event information of the second terminal device 20. Further, the communication performance command that is transmitted to the second terminal device 20 is a performance command for performing data reception from the second terminal device 20, and includes the first event information of the first terminal 10.

Accordingly, the first terminal device 10 and the second terminal device 20 transmit/receive the data by performing communication according to the received communication performance command (operation S114). Specifically, if the communication performance command is received, the first terminal device 10 searches for the data based on the first path information, and transmits the searched data to the second terminal device 20 based on the identification information included in the received communication performance command, that is, the address information. The second terminal device 20, which has received the data from the first terminal device 10 stores the received data based on the second path information.

As described above, the communication system according to the present disclosure can perform the data processing such as copy, cut, and paste of the data between the first and second terminal devices 10 and 20 which use different protocols.

Above, the method for performing the communication between the virtual or actual terminal devices in the communication system according to the present disclosure has been described in detail. Hereinafter, the configurations of the above-described first terminal device 10 and second terminal device 20 will be described.

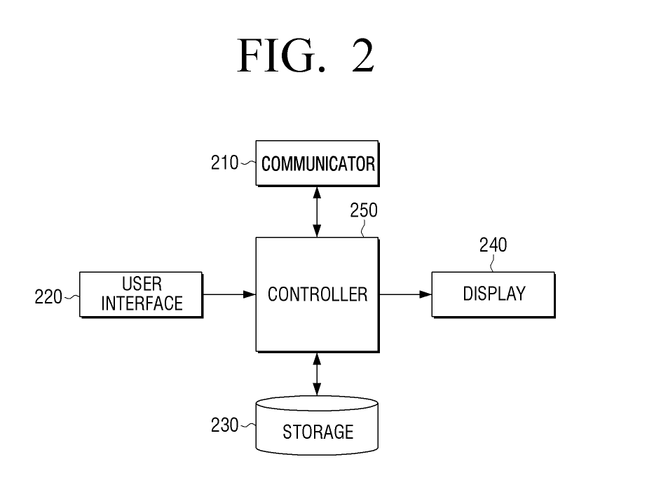

FIG. 2 is a block diagram of a terminal device, in which a virtual environment is constructed, providing data to the other terminal device according to an embodiment of the present disclosure.

As illustrated in FIG. 2, the terminal device, in which the virtual environment is constructed, may be a source terminal device that provides the data to the other terminal device, in which the virtual environment is constructed, that is, the second terminal device 20. Here, the virtual environment is an execution environment that is generated based on the resources stored in the external server. Accordingly, the virtual Windows environment can be constructed in the first terminal device 10 and the second terminal device 20 based on the resources stored in the external server. However, the present disclosure is not limited thereto. The first terminal device 10 or the second terminal device 20 may be a terminal device in which the virtual environment is constructed, and the other one thereof may be a terminal device in which the actual Windows environment is constructed.

As described above, the first terminal device 10, in which the virtual environment is constructed, includes a communicator 210, a user interface 220, a storage unit 230, a display 240, and a controller 250.

The communicator 210 performs communication with the management server 30 and the other terminal device, that is, the second terminal device 20. This communicator 210 may be implemented by a communication module, such as a near field communication module (not illustrated) and a wireless communication module (not illustrated). The communicator 210 implemented by the wireless communication module can be connected to an external network according to a wireless communication protocol and perform communication with the management server 30 and the second terminal device 20. In particular, the communicator 210 may be implemented by a wireless communication module, and perform communication with the second terminal device 20 in a P2P (Peer to Peer) method. However, the present disclosure is not limited thereto. The communicator 210 may perform communication with the second terminal device 20 through the external server according to a network topology type, or perform communication with the second terminal device 20 using a file transfer protocol, such as HTTP (Hyper Text Transfer Protocol) and FTP (File Transfer Protocol), for example, and the network position.

On the other hand, the management server 30 that performs communication through the communicator 210 is a server that performs a communication performance command for transmitting/receiving the data by performing the communication between the first terminal device 10 and the second terminal device 20. The second terminal device 20 that performs the communication through the communicator 210 is a terminal device in which the virtual environment or actual Windows environment is constructed and which transmits/receives the data with the first terminal device 10.

The user interface 220 receives the processing command for the data searched according to the data search command, and the storage unit 230 stores the first path information for the position of the searched data. The controller 250 transmits the first event information related to the processing command received through the user interface 220 to the management server 30.

Specifically, the controller 250 activates the Windows explorer according to the user command input through the user interface 220. Accordingly, the display 240 displays the activated Windows explorer, and thus an activated Windows explorer window may be displayed on a screen. As described above, the user interface 220 receives the data search command for at least one piece of data among a plurality of pieces of pre-stored data in state where the Windows explorer window is displayed. If the data search command is received, the controller 250 searches for the data that corresponds to the data search command. Thereafter, if the processing command for the searched data is received through the user interface, the storage unit 230 stores the first path information on the position where the searched data is stored according to a control command of the controller 250. Here, the processing command for the searched data may be one of cut, copy, and drag for the corresponding data. The first path information includes the local directory in which the searched data is stored and the data position information. If the processing command for copy is received, the controller 250 may control the storage unit 230 to store the first path information including the local directory and the data position information to perform copy of the searched data based on the received processing command.

If the processing command for the searched data is received through the user interface 220, the controller 250, which controls the storage unit 230 to store the first path information on the searched data, generates and transmits the first event information related to the received processing command to the management server 30. Here, the first event information includes the event information for performing one of cut, copy, and drag with respect to the searched data and the identification information of the first terminal device 10, that is, address information.

Thereafter, if the communication performance command that includes the identification information of the second terminal device 20, that is, the address information, is received from the management server 30, the controller 250 operates to transmit the data to the second terminal device 20 based on the address information included in the received communication performance command and the first path information stored in the storage unit 230. Here, the communication performance command received from the management server 30 is a command that is generated based on the second event information related to the execution command in the second terminal device 20 and the first event information. In other words, the communication performance command is a command that is generated based on the first event information related to the processing command for the searched data in the first terminal device 10 and the second event information related to the execution command for the corresponding data in the second terminal device 20.

As described above, the first event information is event information for one processing command of cut, copy, and drag for the searched data, and the second event information is event information for one execution command of paste and drop for the searched data.

Specifically, the management server 30, which has received the first event information related to the processing command for the searched data from the first terminal device 10, can receive the second event information related to the execution command for the corresponding data from the second terminal device 20. As described above, if both the first event information related to the processing command for the searched data and the second event information related to the execution command for the searched data are received, the management server 30 transmits the communication performance command that includes the identification information included in the second event information received from the second terminal device 20 to the first terminal device 10. Further, the management server 30 transmits the communication performance command that includes the identification information included in the second event information received from the first terminal device 10 to the second terminal device 20.

As described above, if the communication performance command that includes the identification information of the second terminal device 20, that is, the address information, is received from the management server 30, the controller 250 searches for the data to be transmitted to the second terminal device 20 based on the first path information stored in storage unit 230. Thereafter, the controller 250 transmits the searched data to the second terminal device 20 based on the address information included in the received communication performance command. As described above, the first terminal device 10 according to the present disclosure can transmit the searched data to the second terminal device 20 that uses the different protocol.

Above, the operation of transmitting the data from the first terminal device 10 in which the virtual environment is constructed to the second terminal device 20 that uses the different protocol has been described in detail. Hereinafter, the operation of receiving the data from the first terminal device 10 that uses the different protocol, which is performed by the second terminal device 20 in which the virtual environment is constructed according to the present disclosure, will be described in detail.

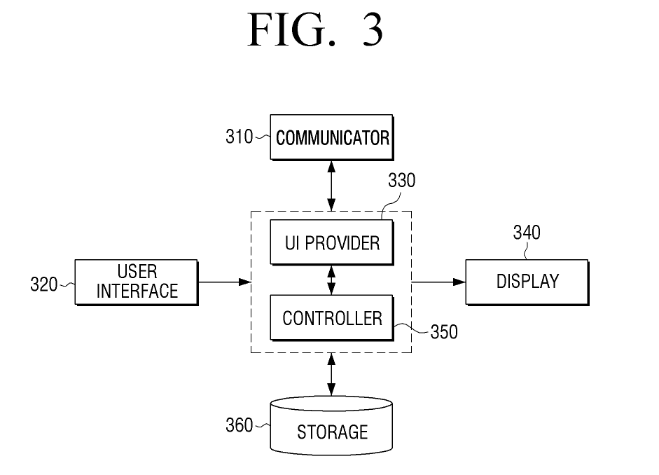

FIG. 3 is a block diagram of a terminal device, in which a virtual environment is constructed, receiving data of the other terminal device according to an embodiment of the present disclosure.

As illustrated in FIG. 3, the terminal device in which the virtual environment is constructed may be the second terminal device 20 as described above, and may be the target terminal device that receives the data provided from the other terminal device in which the virtual environment is established, that is, the first terminal device 10. Here, the virtual environment is an execution environment that is generated based on the resources stored in the external server. Accordingly, in the first terminal device 10 and the second terminal device 20, the virtual Windows environments may be constructed based on the resources stored in the external server. However, the present disclosure is not limited thereto. The second terminal device 20 may be a terminal device in which the virtual environment is constructed, and the first terminal device 10 may be a terminal device in which the actual Windows environment is established.

As described above, the second terminal device 200, in which the virtual environment is constructed, includes a communicator 310, a user interface 320, a UI provider 330, a display 340, and a controller 350.

The communicator 310 performs communication with the management server 30 and the other terminal device, that is, the first terminal device 10. This communicator 310 may be implemented by a communication module, such as a near field communication module (not illustrated) and a wireless communication module (not illustrated). The communicator 310 implemented by the wireless communication module can be connected to an external network according to a wireless communication protocol and perform communication with the management server 30 and the first terminal device 10. In particular, the communicator 310 may be implemented by a wireless communication module, and perform communication with the first terminal device 10 in a P2P (Peer to Peer) method. However, the present disclosure is not limited thereto. The communicator 310 may perform communication with the first terminal device 10 through the external server according to the network topology type, or perform communication with the first terminal device 10 using a file transfer protocol, such as HTTP (Hyper Text Transfer Protocol) and FTP (File Transfer Protocol), for example, and the network position.

On the other hand, the management server 30 that performs communication through the communicator 310 is a server that performs a communication performance command for transmitting/receiving the data by performing the communication between the first terminal device 10 and the second terminal device 20. The first terminal device 10 that performs the communication through the communicator 310 is a terminal device in which the virtual environment or actual Windows environment is constructed and which transmits/receives the data with the second terminal device 20.

The user interface 320 receives the data search command, and the UI provider 330 receives the first event information of the first terminal device 10 from the management server 30 according to the data search command received through the user interface 320. Thereafter, the UI provider 330 provides the UI for executing the data stored in the first terminal device 10 based on the received first event information. Accordingly, the display 340 may display the UI for executing the data provided through the UI provider 330 on the screen. If the execution command is received through the UI displayed on the screen, the controller 350 transmits the second event information related to the received execution command to the management server 30.

Specifically, the controller 350 activates the Windows explorer according to the user command input through the user interface 320. Accordingly, the display 340 displays the activated Windows explorer, and thus the user can request the search command for specific data through the Windows explorer window being displayed on the screen. If the data search command according to such a request is received through the user interface 320, the controller 350 generates and transmits the event occurrence message that notifies of the reception of the data search command to the management server 30. However, the present disclosure is not limited thereto. If the Windows explorer is activated according to the user command input through the user interface 320, the controller 350 may transmit the event occurrence message that notifies of the activation of the Windows explorer to the management server 30.

The management server 30, which has received the event occurrence message, transmits the first event information that is stored in relation to the data processing command of the first terminal device 10 to the second terminal device 20. If the first event information of the first terminal device 10 is received from the management server 30 through the communicator 310, the UI provider 330 provides the UI for executing the data stored in the first terminal device 10 based on the received first event information according to the control command of the controller 350. Here, the first event information may be event information to perform one of cut, copy, and dray for the data to be provided by the first terminal device 10. According to such first event information, the UI controller 330 may provided the UI for executing the data stored in the first terminal device 10. If the execution command for the corresponding UI is received from the user through the user interface 320 when the UI is displayed on the screen, the controller 350 transmits the second event information related to the received execution command to the management server 30. Here, the execution command may be one of paste for storing the data stored in the first terminal device 10 in a specific position and drop. Further, the second event information includes the event information for performing one execution of paste and drop for the stored data in the terminal device 10, that is, address information.

On the other hand, the second terminal device 20 according to the present disclosure may further include a storage unit 360 for storing the second path information to execute the data stored in the first terminal device 10. Specifically, if the execution command for the UI is received, the controller 350 generates the second path information for executing the data stored in the first terminal device 10 in the specific position, and controls the storage unit 360 to store the generated second path information. Here, the second path information includes local directory information for storing the data stored in the first terminal device 10 in the specific position. If the execution command for paste is received, the controller 350 generates the second path information including the local directory information related to the specific position to perform paste for the data stored in the first terminal device 10 based on the received execution command and stores the generated second path information in the storage unit 360.

That is, if the execution command for the UI is received, the controller 350 transmits the second event information related to the received execution command to the management server 30, and at the same time, generates the second path information for executing the data stored in the first terminal device 10 to store the generated second path information in the storage unit 360.

Thereafter, if the communication performance command that includes the identification information of the first terminal device 10, that is, the address information, is received from the management server 30, the controller 350 receives the data from the first terminal device 10 by performing communication with the first terminal device 10 according to the identification information included in the received communication performance command, that is, the address information. Here, the communication performance command received from the management server 30 is a command that is generated based on the first event information related to the processing command for the searched data in the first terminal device 10 and the second event information related to the execution command for the corresponding data in the second terminal device 20.

Specifically, the management server 30, which has received the first event information related to the processing command for the searched data from the first terminal device 10, can receive the second event information related to the execution command for the corresponding data from the second terminal device 20. As described above, if both the first event information and the second event information are received from the first terminal device 10 and the second terminal device 20, the management server 30 transmits the communication performance command that includes the identification information included in the second event information received from the second terminal device 20 to the first terminal device 10. Further, the management server 30 transmits the communication performance command that includes the identification information included in the first event information received from the first terminal device 10 to the second terminal device 20.

As described above, if the communication performance command that includes the identification information of the first terminal device 10, that is, the address information, is received from the management server 30, the controller 350 performs communication with the first terminal device 10 based on the address information included in the received communication performance command. Thereafter, if the data is received from the first terminal device 10 through the communicator 310, the controller 250 may store the received data in the specific position by performing the execution in the corresponding specific position that corresponds to the second path information stored in the storage unit 360.

Above, the operation of performing data transmission/reception with the virtual or actual terminal device through the respective configurations of the terminal device in which the virtual environment is constructed has been described in detail. Hereinafter, the operation of performing data transmission/reception with the virtual or actual terminal device in the terminal device, in which the virtual environment is constructed, will be described in detail.

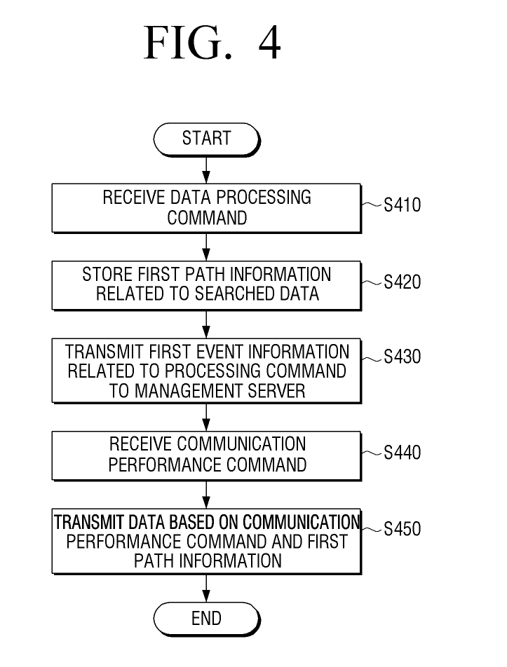

FIG. 4 is a flowchart of a method for providing data from a terminal device, in which a virtual environment is constructed, to a virtual or actual terminal device according to an embodiment of the present disclosure.

As illustrated in FIG. 4, the terminal device, in which the virtual environment is constructed, is the first terminal device 10, which may be a source terminal device that provides the data to the other terminal device, in which the virtual environment is constructed, that is, the second terminal device 20. Here, the virtual environment is an execution environment that is generated based on the resources stored in the external server. Accordingly, the virtual Windows environment can be constructed in the first terminal device 10 and the second terminal device 20 based on the resources stored in the external server. However, the present disclosure is not limited thereto. If the first terminal device 10 is the terminal device, in which the virtual environment is constructed, the second terminal 20 may be the terminal device in which the actual Windows environment is constructed.

As described above, the first terminal device 10, in which the virtual environment is constructed, receives the processing command for the data that is searched for according to the data search command (operation S410). Specifically, the first terminal device 10 may activate the data searcher according to the user request. If the data search command for at least one piece of data among a plurality of pieces of pre-stored data is received from the user when the data searcher is activated, the first terminal device 10 searches for the data that corresponds to the received data search command. Thereafter, if the processing command for the searched data is received, the first terminal device 10 stores the first path information for the position where the searched data is stored (operation S420). Here, the processing command for the searched data may be one of cut, copy, and drag for the corresponding data. The first path information includes the local directory in which the searched data is stored and the data position information. If the processing command for cut is received, the first terminal device 10 generates and stores the first path information that includes the local directory and the data position information to perform cut of the searched data based on the received processing command.

The first terminal device 10, which has stored the first path information, generates the first event information related to the processing command for the searched data and transmits the generated first event information to the management server 30 (operation S430). Here, the first event information includes the event information for performing one processing of cut, copy, and drag for the searched data and the identification information of the first terminal device 10, that is, the address information.

Thereafter, if the communication performance command that includes the identification information of the second terminal device 20, that is, the address information, is received from the management server 30, the first terminal device 10 transmits the searched data to the second terminal device 20 based on the address information included in the received communication performance command and the pre-stored first path information. Here, the management server 30 is a server which performs communication between the first terminal device 10 that is the source terminal device and the second terminal device 20 that is the target terminal device, and transmits the communication performance command for transmitting/receiving the data to the first and second terminal devices 10 and 20. Specifically, the management server 30 receives and stores the first event information related to the processing command for the searched data from the first terminal device 10. Further, the management server 30 may receive the second event information related to the performance command for the searched data in the first terminal device 10 from the second terminal device 20 (operation S440). As described above, if both the first event information and the second event information are received, the management server 30 transmits the communication performance command that includes the identification information included in the second event information received from the second terminal device 20 to the first terminal device 10. Further, the management server 30 transmits the communication performance command that includes the identification information included in the first event information received from the first terminal device 10 to the second terminal device 20 (operation S450).

Accordingly, if the communication performance command is received from the management server 30, the first terminal device 10 searches for the data transmitted to the second terminal device 20 based on the pre-stored first path information. Thereafter, the first terminal device 10 transmits the searched data to the second terminal device 20 by performing communication with the second terminal device 20 based on the identification information included in the communication performance command received from the management server 30, that is, the address information. According to embodiments, the first terminal device 10 may transmit the searched data to the second terminal device 20 by performing communication with the second terminal device 20 in a P2P method. However, the present disclosure is not limited thereto. The first terminal device 10 may transmit the searched data to the second terminal device 20 through the external server according to the network topology type, or may transmit the searched data to the second terminal device 20 using the file transfer protocol, such as HTTP and FTP, and the network position. As described above, the first terminal device 10 in which the virtual environment is constructed according to the present disclosure can transmit the searched data to the second terminal device 20 that is the virtual or actual terminal device using the different protocol.

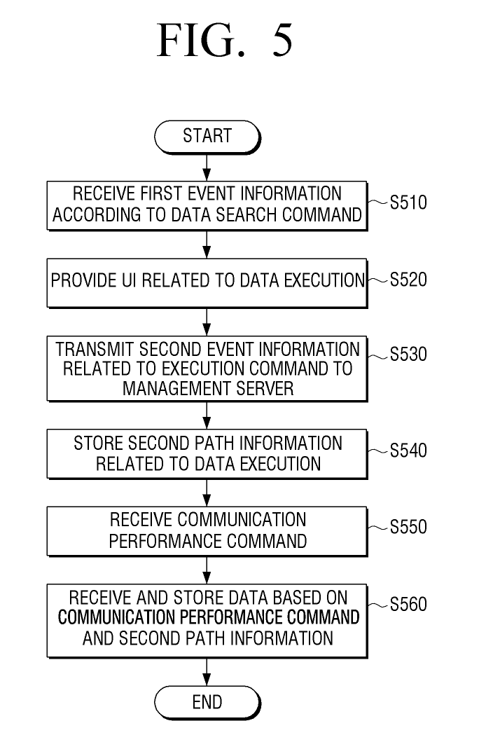

FIG. 5 is a flowchart of a method for receiving data of a virtual or actual terminal device through a terminal device in which a virtual environment is constructed according to an embodiment of the present disclosure.

As illustrated in FIG. 5, the terminal device in which the virtual environment is constructed may be the second terminal device 20 as described above, and may be the target terminal device that receives the data provided from the other terminal device in which the virtual environment is established, that is, the first terminal device 10. In this case, the first terminal device 10 that provides the data may be the source terminal device. Further, the virtual environment is an execution environment that is generated based on the resources stored in the external server. Accordingly, in the first terminal device 10 and the second terminal device 20, the virtual Windows environments may be constructed based on the resources stored in the external server. However, the present disclosure is not limited thereto. The second terminal device 20 may be a terminal device in which the virtual environment is constructed, and the first terminal device 10 may be a terminal device in which the actual Windows environment is established.

If the data search command is received from the user, the second terminal 200, in which the virtual environment is constructed, receives the first event information of the first terminal device 10 from the management server 30 according to the received data search command (operation S510). Specifically, the second terminal device 20 may activate the data searcher according to the user request. If the data search command is received from the user when the data searcher is activated, the second terminal device 20 generates and transmits an event occurrence message that notifies of the reception of the data search command to the management server 30. However, the present disclosure is not limited thereto. If the Windows explorer is activated according to the user command, the second terminal device 20 may transmit the event occurrence message that notifies of the activation of the Windows explorer to the management server 30.

The management server 30, which has received the event occurrence message, transmits the first event information that is stored in relation to the processing command for the searched data in the first terminal device 10 to the second terminal device 20. Here, the first event information may be the event information for performing one of cut, copy, and drag for the data provided from the first terminal device 10. If the first event information is received from the management server 30, the second terminal device 20 provides the UI for executing the data stored in the first terminal device 10 based on the received first event information (operation S520).

If the execution command for the corresponding UI is received from the user when the UI for data execution is displayed on the screen, the second terminal device 20 generates and transmits the second path information related to the received execution command to the management server 30 (operation S530). Here, the execution command may be one of paste for storing the data stored in the first terminal device 10 in a specific position and drop. Further, the second event information includes the event information for performing one of paste and drop for the data stored in the first terminal device 10 and the identification information of the second terminal device 20, that is, the address information.

The second terminal device 20, which transmits the second event information to the management server 30 according to the received execution command, generates and stores the second path information for executing (or storing) the data stored in the first terminal device 10 in the specific position (operation S540). Here, the second path information includes the local directory information for storing the data stored in the first terminal device 10 in the specific position. If the execution command for paste is received, the second terminal device 20 may generate the second path information including the local directory information related to the specific position to perform paste for the data stored in the first terminal device 10 based on the received execution command for paste and store the generated second path information.

Thereafter, if the communication performance command that includes the identification information of the first terminal device 10, that is, the address information, is received from the management server 30, the second terminal device 20 receives the data from the first terminal device 10 by performing communication with the first terminal device 10 according to the address information included in the received communication performance command (operation S550). According to the embodiments, the second terminal device 20 may receive the data from the first terminal device 10 by performing communication with the first terminal device 10 in a P2P method. However, the present disclosure is not limited thereto. The second terminal device 20 may receive the data from the first terminal device 10 through the external server according to the network topology type, or may receive the data from the first terminal device 10 using the file transfer protocol, such as HTTP and FTP, for example, and the network position.

On the other hand, as described above, the communication performance command received from the management server 30 is a command that is generated based on the first event information related to the processing command for the searched data in the first terminal device 10 and the second event information related to the execution command for the corresponding data in the second terminal device 20.

Specifically, the above-described management server 30 is a server which transmits the communication performance command for transmitting/receiving the data to/from the first and second terminal devices 10 and 20 by performing communication between the first terminal device 10 that is the source terminal device and the second terminal device 20 that is the target terminal device. That is, the management server 30 receives and stores the first event information related to the performance command for the searched data from the first terminal device 10. Further, the management server 30 may receive the second event information related to the performance command for the searched data in the first terminal device 10 from the second terminal device 20 (operation S560). As described above, if both the first event information and the second event information are received, the management server transmits the communication performance command that includes the identification information, that is, address information, included in the second event information received from the second terminal device 20, to the first terminal device 10. Further, the management server 30 transmits the communication performance command that includes the identification information included in the first event information received from the first terminal device 10 to the second terminal device 20.

Accordingly, the second terminal device 20, which has received the communication performance command including the address information of the first terminal device 10, performs communication with the first terminal device 10, which has received the communication performance command including the address information of the second terminal device 20. Thereafter, if the searched data is received from the first terminal device 10, the second terminal device 20 may store the data received in the corresponding specific position by performing the execution in the specific position that corresponds to the pre-stored second path information.

As described above, the second terminal device 20, in which the virtual environment is constructed, according to the present disclosure can store the data received from the first terminal device 10 that is the virtual or actual terminal device using the different protocol in the specific position.

Above, the preferred embodiments of the present disclosure have been described.

The above-described embodiments may be recorded in computer-readable media including program instructions to implement various operations embodied by a computer. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

While the present disclosure has been shown and described with reference to certain embodiments thereof, it will be understood by those skilled in the art that various changes in form and detail may be made therein without departing from the spirit and scope of the present disclosure, as defined by the appended claims.

What is claimed is:

1. A data communication method of a first terminal device in which a virtual environment is constructed, comprising:
receiving, by the first terminal device, a processing command for data searched for according to a data search command;
storing, by the first terminal device, first path information on a position of the searched data and transmitting first event information related to the processing command to a management server;
receiving, by the first terminal device, a communication performance command including identification information of the second terminal from the management server; and
transmitting, by the first terminal device, the data to the second terminal based on the identification information and the first path information,
wherein the communication performance command is generated based on second event information related to an execution command for the data in the second terminal device and the first event information.

2. The data communication method as claimed in claim 1, wherein the first event information comprises one of data cut, copy, and drag, and
the second event information comprises one of data paste and drop.

3. The data communication method as claimed in claim 1, wherein the first terminal device comprises a source terminal device that provides the data, and
the second terminal device comprises a target terminal device that receives the data from the source terminal device.

4. The data communication method as claimed in claim 1, wherein the virtual environment comprises an execution environment that is generated based on resources stored in an external server.

5. The data communication method as claimed in claim 1, wherein the first terminal device performs communication with the second terminal device using a Peer to Peer (P2P) method.

6. A data communication method of a second terminal device in which a virtual environment is constructed, comprising:
receiving, by the second terminal device, first event information related to a data processing command of a first terminal device from a management server if a data search command is received;
providing a user interface (UI) for executing data stored in the first terminal device based on the received first event information;
if an execution command is received through the UI, transmitting second event information related to the received execution command to the management server; and
receiving the data by performing communication with the first terminal device according to a communication performance command received from the management server,
wherein the communication performance command is generated based on the first event information and the second event information.

7. The data communication method as claimed in claim 6, further comprising:
storing second path information to execute the data if the execution command is input; and
storing the received data in a position that corresponds to the second path information.

8. The data communication method as claimed in claim 6, wherein the first event information comprises one of data cut, copy, and drag, and
the second event information comprises one of data paste and drop.

9. The data communication method as claimed in claim 6, wherein the second terminal device comprises a target terminal device that receives the data,
the first terminal device comprises a source terminal device that provides the data, and
the virtual environment comprises an execution environment that is generated based on resources stored in an external server.

10. The data communication method as claimed in claim 6, wherein the second terminal device performs communication with the first terminal device using a Peer to Peer (P2P) method.

11. A first terminal device in which a virtual environment is constructed, comprising:
a communicator performing communication with a management server and a second terminal device;
a user interface receiving and using a processing command for data searched for according to a data search command;
a storage unit storing first path information on a position of the searched data; and
a controller transmitting first event information related to the processing command to the management server, and if a communication performance command including identification information of the second terminal device is received from the management server, transmitting the data to the second terminal based on the identification information and the first path information,
wherein the communication performance command is generated based on second event information related to an execution command for the data in the second terminal device and the first event information.

12. The terminal device as claimed in claim 11, wherein the first event information comprises one of data cut, copy, and drag, and
the second event information comprises one of data paste and drop.

13. The terminal device as claimed in claim 11, wherein the first terminal device comprises a source terminal device that provides the data, and
the second terminal device comprises a target terminal device that receives the data from the source terminal device.

14. The first terminal device as claimed in claim 11, wherein the virtual environment comprises an execution environment that is generated based on resources stored in an external server.

15. The first terminal device as claimed in claim 11, wherein the communicator performs communication with the second terminal device using a Peer to Peer (P2P) method.

16. A second terminal device in which a virtual environment is constructed, comprising:
a communicator performing communication with a management server and a first terminal device;
a user interface (UI) receiving a data search command;
a UI provider receiving first event information from the management server if the data search command is received, and providing a UI for executing data stored in the first terminal device based on the received first event information; and
a controller transmitting second event information related to an execution command to the management server if the execution command is received through the UI, and performing communication with the first terminal device according to a communication performance command received from the management server to receive the data,
wherein the communication performance command is generated based on the first event information and the second event information.

17. The second terminal device as claimed in claim 16, further comprising a storage unit storing second path information to execute the data,
wherein the controller executes the received data in a specific position that corresponds to the second path information if the data is received.

18. The second terminal device as claimed in claim 16, wherein the first event information comprises one of data cut, copy, and drag, and
the second event information comprises one of data paste and drop.

19. The second terminal device as claimed in claim 16, wherein the second terminal device comprises a target terminal device that receives the data,
the first terminal device comprises a source terminal device that provides the data, and
the virtual environment comprises an execution environment that is generated based on resources stored in an external server.

20. The second terminal device as claimed in claim 16, wherein the second terminal device performs communication with the first terminal device using a Peer to Peer (P2P) method.
